(19) United States
(12) Patent Application Publication
(10) Pub. No.: US 2016/0335889 A1
(43) Pub. Date: Nov. 17, 2016

(54) INTEGRATED LAMP ASSEMBLY AND METHOD

(71) Applicant: ALSTOM TRANSPORT TECHNOLOGIES, Saint-Ouen (FR)

(72) Inventors: Nicholas David Nagrodsky, Melbourne, FL (US); Timothy Scott Zibrat, Melbourne, FL (US); Fenton Fitzpatrick, Melbourne, FL (US); Michael Carter, Melbourne, FL (US); Christopher Lewis, Melbourne, FL (US); Brandon Gaskin, Melbourne, FL (US)

(21) Appl. No.: 15/153,046

(22) Filed: May 12, 2016

Related U.S. Application Data
(60) Provisional application No. 62/161,623, filed on May 14, 2015.

(51) Int. Cl. G08G 1/081

(52) U.S. Cl. CPC G08G 1/081

(57) ABSTRACT

A signaling system and method provide a first lamp assembly including one or more light generating devices configured to activate to inform an operator of a vehicle system of information related to movement of the vehicle system. The first lamp assembly includes processing circuitry configured to control and monitor operation of the one or more light generating devices. A wayside station is configured to be communicatively coupled with the first lamp assembly by a single conductive communication pathway. The wayside station is configured to conduct electric current to power the first lamp assembly and to communicate with the processing circuitry of the first lamp assembly via the single conductive communication pathway.

### FIELD

Embodiments of the subject matter disclosed herein relate to signaling systems used to inform operators of vehicle systems.

### BACKGROUND

Transportation networks such as rail networks use lights to communicate information with operators of vehicles traveling in the network. For example, signal aspects may be used to warn operators of trains of reduced speed limits, prohibited sections of track, crossings with other routes, or the like. These signal aspects typically are controlled by a wayside device, such as a signaling bungalow.

The wayside device that controls the signal aspects usually is connected with each signal aspect by several wires. Some wires are used to allow circuitry in the wayside device to monitor operations of the signal aspects, and other wires are used to supply current to the signal aspects to power the signal aspects. The signal aspects can be located relatively far from the wayside device that controls the signal aspects.

As the signal aspects are installed farther from the wayside devices that control the signal aspects, the cost and complexity of controlling and powering the signal aspects significantly increases. Running several wires to each signal aspect can increase the cost of cable runs required to control the signal aspects. Additionally, because the signal aspects typically operate using direct current, supplying the direct current from the wayside device to the signal aspects over long distances can be a costly and complex technique for powering the signal aspects.

### BRIEF DESCRIPTION

In an embodiment, a system (e.g., a signaling system) includes a first lamp assembly including one or more light generating devices configured to activate to inform an operator of a vehicle system of information related to movement of the vehicle system. The first lamp assembly includes processing circuitry configured to control and monitor operation of the one or more light generating devices. The system also includes a wayside station configured to be communicatively coupled with the first lamp assembly by a single conductive communication pathway. The wayside station is configured to conduct electric current to power the first lamp assembly and to communicate with the processing circuitry of the first lamp assembly via the single conductive communication pathway.

In an embodiment, another system (e.g., another signaling system) includes a first lamp assembly including one or more light generating devices configured to activate to inform an operator of a vehicle system of information related to movement of the vehicle system. The first lamp assembly includes processing circuitry configured to control and monitor operation of the one or more light generating devices. The system also includes a wayside station configured to be communicatively coupled with the first lamp assembly by a wireless communication pathway, wherein the first lamp assembly is configured to communicate with the processing circuitry of the first lamp assembly via the wireless communication pathway.

In an embodiment, another system (e.g., a signaling system) includes a first lamp assembly including one or more light generating devices configured to activate to inform an operator of a vehicle system of information related to movement of the vehicle system. The first lamp assembly includes processing circuitry configured to control and monitor operation of the one or more light generating devices. The first lamp assembly is configured to be communicatively coupled with the wayside station by a single conductive communication pathway. The first lamp assembly is configured to receive electric current to power the first lamp assembly from the wayside station and to communicate with the wayside station via the single conductive communication pathway.

In an embodiment, a system (e.g., a signaling system) includes a first lamp assembly including one or more light generating devices configured to activate to inform an operator of a vehicle system of information related to movement of the vehicle system. The first lamp assembly includes processing circuitry configured to control and monitor operation of the one or more light generating devices. The first lamp assembly can be configured to be communicatively coupled with the wayside station by a wireless communication pathway, where the first lamp assembly is configured to communicate with the processing circuitry of the first lamp assembly via the wireless communication pathway.

In an embodiment, a method includes coupling processing circuitry with one or more light generating devices of a first lamp assembly. The one or more light generating devices are configured to activate to inform an operator of a vehicle system of information related to movement of the vehicle system. The method also includes coupling the processing circuitry with a wayside station, monitoring operation of the one or more light generating devices using the processing circuitry of the first lamp assembly, and communicating information about the operation of the one or more light generating devices to the wayside station from the processing circuitry.

### BRIEF DESCRIPTION OF THE DRAWINGS

Reference is made to the accompanying drawings in which particular embodiments and further benefits of the invention are illustrated as described in more detail in the description below, in which:

FIG. 1 illustrates one embodiment of a signaling system;

FIG. 2 is another illustration of one embodiment of the signaling system shown in FIG. 1;

FIG. 3 illustrates one embodiment of control circuitry of the lamp assembly shown in FIG. 2;

FIG. 4 illustrates another embodiment of a signaling system;

FIG. 5 is illustrates another embodiment of a signaling system; and

FIG. 6 illustrates a flowchart of one embodiment of a method for providing lamp assemblies in a signaling system.

### DETAILED DESCRIPTION

Embodiments of the inventive subject matter described herein relate to lamp assemblies and methods for providing lamp assemblies used in connection with directing movements of vehicle systems, such as rail vehicles, automobiles, or the like. The lamp assemblies described herein include light generating devices (e.g., bulbs, light emitting diodes, or the like) that are activated to inform operators of vehicle systems of information related to controlling movement of the vehicle systems, such as speed limits, hazards, locations where the vehicle systems are not allowed to enter, or the like. In contrast to some known lamp assemblies, the lamp assemblies described herein include processing circuitry inside the lamp assemblies, where the processing circuitry controls operations of the lamp assemblies. Placing the processing circuitry inside the lamp assemblies (instead of at a centralized wayside station that controls operations of multiple lamp assemblies) reduces the number of cables required to extend from the wayside station to the lamp assemblies, which can reduce the cost, reduce the complexity, and increase the reliability of the lamp assemblies relative to lamp assemblies that are remotely operated from processing circuitry located at the wayside station.

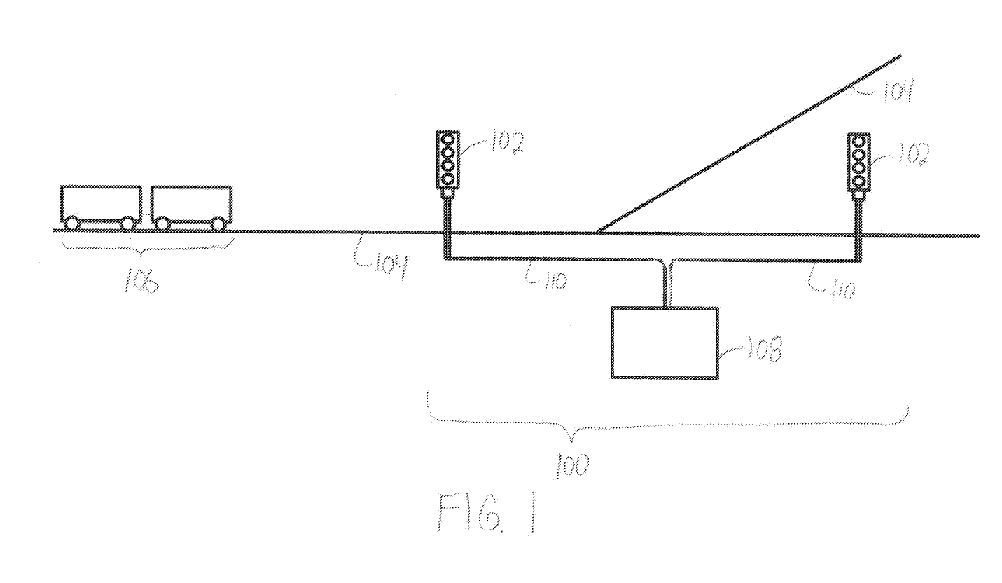

FIG. 1 illustrates one embodiment of a signaling system 100. The signal system 100 includes one or more lamp assemblies 102 disposed alongside routes 104 along which vehicle systems 106 travel. The lamp assemblies 102 include light generating devices, such as incandescent light bulbs, fluorescent lights, light emitting diodes, etc., that are activated to communicate information to operators of the vehicle systems 106. For example, different light generating devices may emit different colored lights to indicate speed limits, upcoming hazards, locations where the vehicle systems 106 are not permitted to travel, the status of one or more upcoming devices (e.g., gates, switches, etc.), or the like. The routes 104 can represent tracks, but optionally may represent roads or other locations where the vehicle systems 106 travel. The vehicle systems 106 can represent rail vehicles (e.g., trains, rail vehicle consists, etc.), other off-highway vehicles (e.g., mining vehicles), automobiles, or the like.

The lamp assemblies 102 are communicatively coupled with a wayside control station 108. The wayside station 108 represents a building (e.g., bungalow) or other structure that houses circuitry for communicating with and/or monitoring operations of the lamp assemblies 102. In one aspect, the wayside station 108 provides electric power to the lamp assemblies 102 via one or more conductive pathways 110, such as cables, wires, or the like. The wayside station 108 can provide power to the lamp assemblies 102 to power the assemblies 102 via a single conductive pathway 110 with each lamp assembly 102. For example, instead of multiple cables or wires extending between the wayside station 108 and each lamp assembly 102, a single wire or cable (having only a single wire) may extend from the wayside station 108 to each lamp assembly 102. Alternatively, the pathway 110 can represent two or more wires, such as a first wire for DC power supply and a second wire for DC return, a first wire for AC hot and a second wire for AC neutral, a first wire for RS485 plus and a second wire for RS485 minus, a first wire for power over Ethernet plus and a second wire for power over Ethernet minus, etc.

The pathway 110 optionally can represent or include a non-conductive connection between the lamp assembly 102 and the wayside station 108. For example, the pathway 110 can represent or include a fiber optic connection between the lamp assembly 102 and the wayside station 108. Such a connection can allow for communication between the lamp assembly 102 and the wayside station 108 that is not negatively impacted by interference such as electromagnetic interference.

The wayside station 108 optionally can communicate with the lamp assemblies 102 over the single conductive pathway 110 with each lamp assembly 102. For example, the wayside station 108 can provide alternating current to a lamp assembly 102 and communicate with the lamp assembly 102 over the same single conductive pathway between the wayside station 108 and the lamp assembly 102. The lamp assembly 102 may use power line communication protocol, power over Ethernet protocol, or another protocol, to communicate with the wayside station 108.

In one aspect, the lamp assembly 102 can communicate safety or vital communications with the wayside station 108 via the single conductive pathway 110 with the wayside station 108. Safety or vital communications include messages or signals that inform the wayside station 108 of the operations of the lamp assembly 102, such as an indication of whether there is an electrical short in the lamp assembly, the status or health of a filament in the lamp assembly 102, an indication of whether there is an open circuit in the lamp assembly 102, an indication of whether the outputs of the lamp assembly 102 are shorted together, results of a test on the temperature of a filament in the lamp assembly 102, an indication of whether the lamp assembly 102 is installed and operational, or other information. The wayside station 108 can communicate with the lamp assemblies 102 via the single conductive pathway 110 with each lamp assembly 102 to control the lamp assemblies 102, such as by directing which lamp assembly 102 is to be activated, which of the light generating devices is to be activated, how long the light generating devices are to be activated, etc.

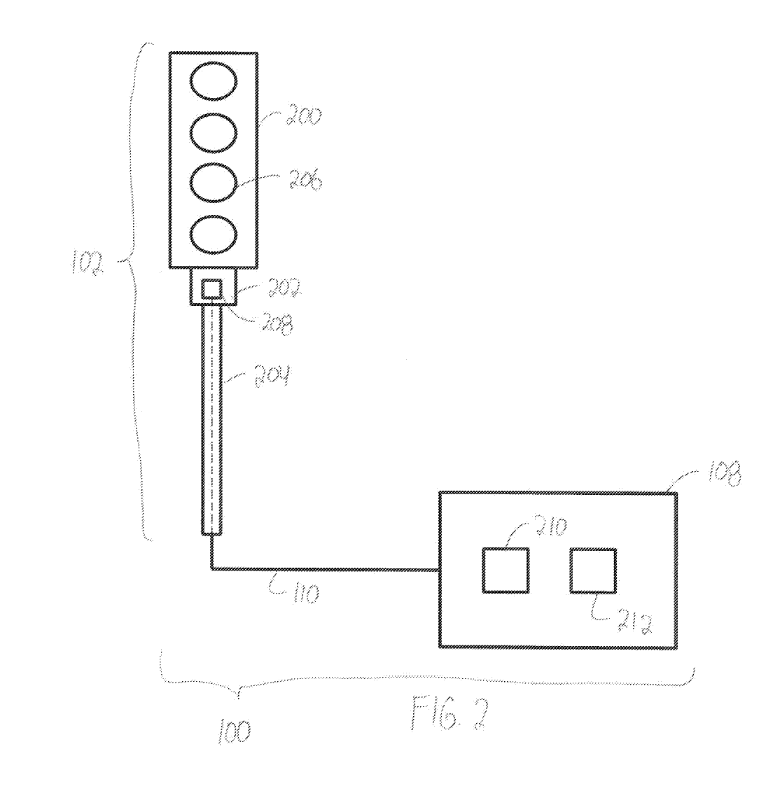

FIG. 2 is another illustration of one embodiment of the signaling system 100. The signaling system 100 is shown with a single lamp assembly 102 communicatively coupled with the wayside station 108, although more than one lamp assembly 102 may be communicatively coupled with the wayside station 108. The lamp assembly 102 includes a signal body 200 and a signal head 202 connected to a supporting structure 204. The supporting structure 204 may include a post, rail, or other body that maintains the signal body 200 at a sufficient height above the route 104 (shown in FIG. 1) that light generating devices 206 in the signal body 200 are visible to operators of the vehicle systems 106 (shown in FIG. 1). Optionally, the lamp assembly 102 may not include the supporting structure 204. For example, the signal body 200 and signal head 202 may be affixed to another structure.

The signal body 200 represents a housing that holds the light generating devices 206. While four light generating devices 206 are shown in FIG. 2, the lamp assembly 102 may include a different number of light generating devices 206 or a single light generating device 206. The signal body 200 may include circuitry, wires, or the like, for powering the light generating devices 206 upon activation of the light generating devices 206. In the illustrated embodiment, the signal head 202 represents a housing connected to the signal body 200 that includes control circuitry 208. The control circuitry 208 can represent hardware circuitry that includes and/or is connected with one or more processors, such as controllers, integrated circuits, microprocessors, or the like. While the control circuitry 208 is shown as being located in the signal head 202 of the lamp assembly 102, alternatively, the control circuitry 208 may be located in the signal body 200.

The wayside station 108 includes a communication unit 210 and processing circuitry 212. The processing circuitry 212 represents hardware circuitry that includes and/or is connected with one or more processors, such as controllers, integrated circuits, microprocessors, or the like. The communication unit 210 can include transceiving circuitry (e.g., antenna, modem, router, or the like) for communication with the lamp assemblies 102 via the single conductive pathways 110 between each lamp assembly 102 and the wayside station 108. The communication unit 210 may communicate with one or more other locations, such as a dispatch facility, scheduling facility, or the like.

The processing circuitry 212 can monitor operation of one or more lamp assemblies 102 based on communication received from the lamp assemblies 102. Based on communication received from the lamp assemblies 102, the processing circuitry 212 can determine which lamp assemblies 102 are fully operational and which are not. In one embodiment, responsive to determining that one or more lamp assemblies 102 are not fully operational, the processing circuitry 212 directs the communication unit 210 to communicate with a repair or scheduling facility located outside of the wayside station 108 to automatically schedule the inspection, repair, or replacement of a lamp assembly 102 and/or light generating device 206.

The processing circuitry 212 can control the transfer of electric current to the lamp assembly 102 via the single conductive pathway 110 in one embodiment. For example, the processing circuitry 212 can control when alternating current is conducted through the pathway 110 to the lamp assembly 102 to power the lamp assembly 102.

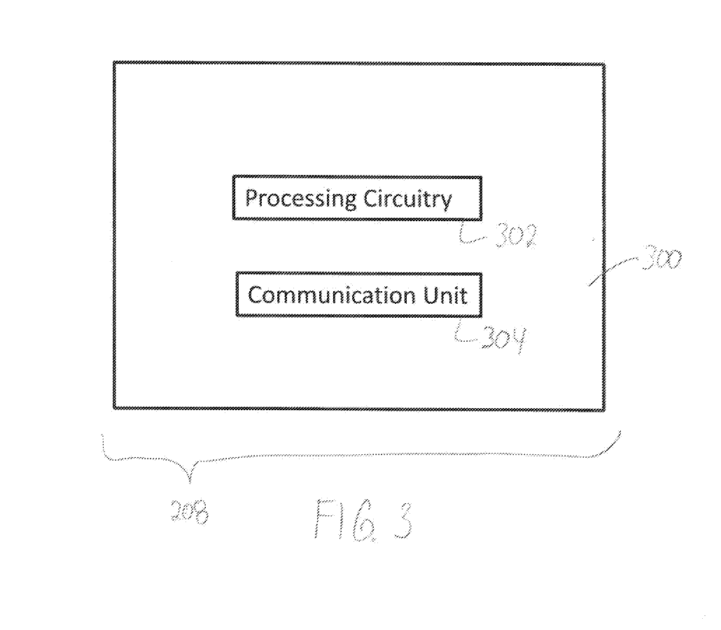

FIG. 3 illustrates one embodiment of the control circuitry 208 of the lamp assembly 102. The control circuitry 208 may include one or more circuits connected to or part of a card 300, such as a PC card or other type of electronic hardware in the shape of a card. Alternatively, the control circuitry 208 may not be in a card 300 and may be provided in another manner, such as separate hardware modules. The control circuitry 208 includes processing circuitry 302 and a communication unit 304. The processing circuitry 302 represents hardware circuitry that includes and/or is connected with one or more processors, such as controllers, integrated circuits, microprocessors, or the like. The processing circuitry 302 can monitor operation of the lamp assembly 102 (shown in FIG. 1).

The communication unit 304 can include transceiving circuitry (e.g., antenna, modem, router, or the like) for communication with the wayside station 108 via the single conductive pathway 110 (shown in FIG. 1) between the lamp assembly 102 and the wayside station 108 (shown in FIG. 1). The processing circuitry 302 can communicate with the wayside station 108 via the communication unit 304 to notify the wayside station 108 of the status of the lamp assembly 102 (e.g., to provide safety or vital communications) and/or to receive direction from the wayside station 108 of which light generating devices 206 (shown in FIG. 2) are to be activated.

Placing the processing circuitry 302 within the lamp assembly 102 can reduce the cost and complexity of the signaling system 100, and can improve reliability of the signaling system 100. The processing circuitry 302 being in the lamp assembly 102 eliminates the need for multiple cables to be run to each lamp assembly 102. The processing circuitry 302 can communicate with the wayside station 108 using a protocol such as power over Ethernet or another protocol. The processing circuitry 302 can perform many, or all, of the safety checks on operation of the lamp assembly 102 instead of the wayside station 108 performing the safety checks. For example, the processing circuitry 302 can examine the light generating devices 206 and associated circuitry to determine if any light generating devices 206 are not operational or have deteriorating health. The processing circuitry 302 can then report any problems to the wayside station 108.

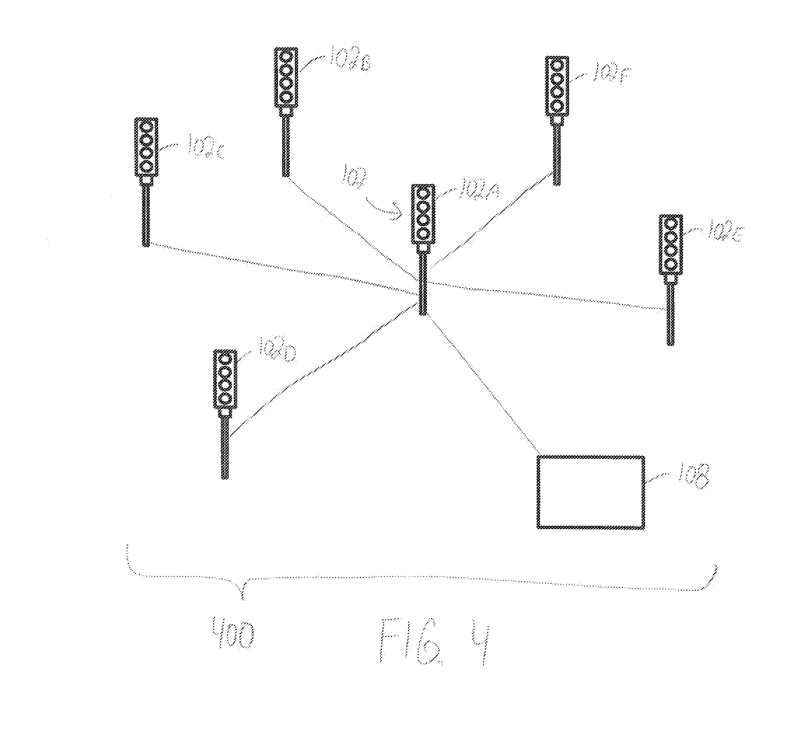

FIG. 4 illustrates another embodiment of a signaling system 400. The signaling system 400 includes several of the lamp assemblies 102 (e.g., lamp assemblies 102A-F) and the wayside station 108. As described above, the wayside station 108 can be connected with the lamp assembly 102A by a single conductive pathway 110 (e.g., a single wire) to supply power to and communicate with the lamp assembly 102A.

With respect to the other lamp assemblies 102B-F, these lamp assemblies 102B-F may be directly communicatively coupled with the lamp assembly 102A and not the wayside station 108. For example, each of the lamp assemblies 102B-F may be coupled with the lamp assembly 102A with a single conductive pathway 110. The lamp assemblies 102B-F may be communicatively coupled with the processing circuitry 302 (shown in FIG. 3) so that the lamp assemblies 102B-F can be controlled and/or monitored by the processing circuitry 302 of the lamp assembly 102A. The lamp assemblies 102B-F may be referred to as slave lamp assemblies while the lamp assembly 102A is referred to as a master lamp assembly. The lamp assemblies 102B-F may not include the processing circuitry 302 in one embodiment. The number of lamp assemblies 102B-F that are coupled with and controlled and/or monitored by the processing circuitry 302 of the lamp assembly 102A may be scalable without adding additional runs of cable from the wayside station 108 to the additional lamp assemblies 102.

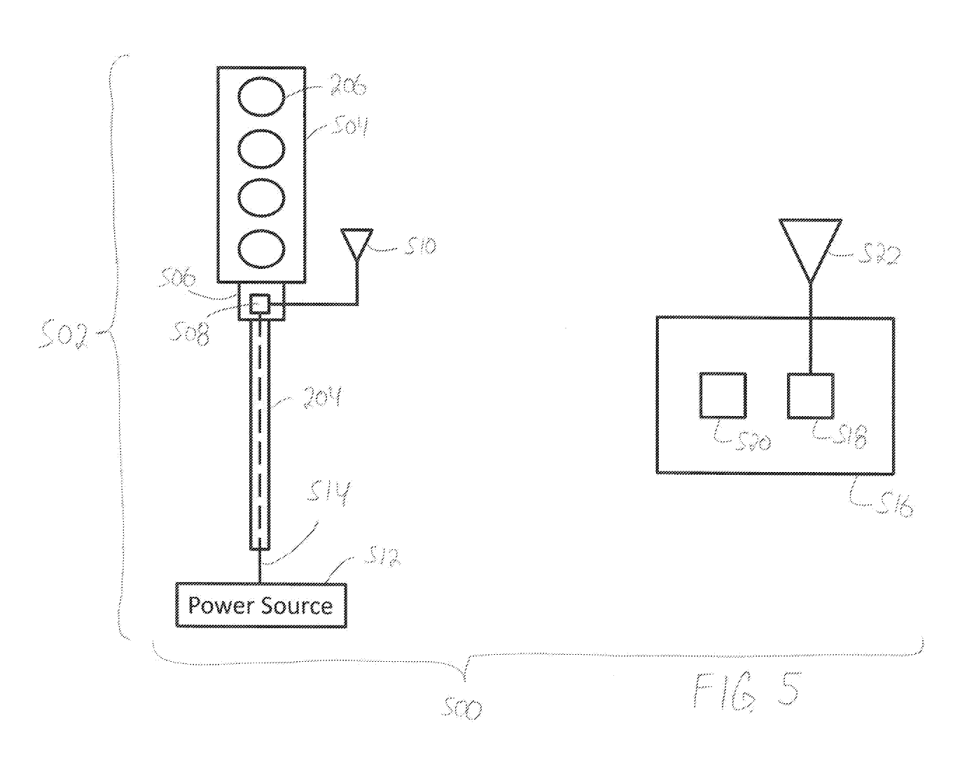

FIG. 5 is illustrates another embodiment of a signaling system 500. The signaling system 500 is shown with a single lamp assembly 502 communicatively coupled with a wayside station 516, although more than one lamp assembly 502 may be communicatively coupled with the wayside station 516. The lamp assembly 502 includes a signal body 504 and a signal head 506 connected to the supporting structure 204. Optionally, the lamp assembly 502 may not include the supporting structure 204.

The signal body 504 represents a housing that holds the light generating devices 206. While four light generating devices 206 are shown in FIG. 5, the lamp assembly 502 may include a different number of light generating devices 206 or a single light generating device 206. The signal body 504 may include circuitry, wires, or the like, for powering the light generating devices 206 upon activation of the light generating devices 206. In the illustrated embodiment, the signal head 506 represents a housing connected to the signal body 504 that includes control circuitry 508. The control circuitry 508 can represent hardware circuitry that includes and/or is connected with one or more processors, such as controllers, integrated circuits, microprocessors, or the like. While the control circuitry 508 is shown as being located in the signal head 506 of the lamp assembly 502, alternatively, the control circuitry 508 may be located in the signal body 504.

Similar to the control circuitry 208 shown in FIG. 3, the control circuitry 508 may include the processing circuitry 302 and communication unit 304 shown in FIG. 3. One difference is that the communication unit of the control circuitry 508 in FIG. 5 includes wireless transceiving circuitry 510 (which includes an antenna) for wireless communication. This wireless transceiving circuitry 510 can allow for the lamp assemblies 502 to wirelessly communicate with the wayside station 516. Optionally, the lamp assemblies 502 can wirelessly communicate with the vehicle systems. For example, the lamp assemblies 502 may wirelessly communicate information, such as warnings, speed limits, gate statuses, statuses of crossings, etc., directly to the vehicle systems without the information first being communicated to one or more other devices or systems outside of the vehicle systems and lamp assemblies.

The wayside station 516 includes a communication unit 518 and processing circuitry 520. The processing circuitry 520 may be similar to the processing circuitry 212 (shown in FIG. 2). The communication unit 518 can include wireless transceiving circuitry 522 (e.g., antenna, modem, router, or the like) for wireless communication with the lamp assembly 502 via the wireless transceiving circuitry 510. In contrast to the lamp assembly 102 and wayside station 108 shown in FIG. 1, the lamp assembly 502 and wayside station 516 can wirelessly communicate for control and/or monitoring of the lamp assembly 502, without a conductive pathway extending from the lamp assembly 502 and the wayside station 516 for communication there between.

Another difference between the signaling system 500 and the signaling system 100 is that the lamp assembly 502 may be connected to a power source 512 that is outside of and separate from the wayside station 516 by one or more conductive pathways 514, such as one or more wires, cables, busses, or the like. The conduction of electric current from the power source 512 to the lamp assembly 502 can power the processing circuitry 508 without the supply of the current being controlled by the wayside station 516. Instead, the processing circuitry 508 can control the conduction of current from the power source 512 to the processing circuitry 508 and light generating devices 206. The power source 512 can represent one or more of an electric utility grid, a solar panel, a flywheel, a battery, a windmill, a generator, an alternator, or the like. The lamp assembly 502 can allow for easier expansion of the signaling system 500 relative to wired signaling systems as additional lamp assemblies 502 may be added to the system 500 without having to run additional lengths of cables or wires to the new lamp assemblies 502.

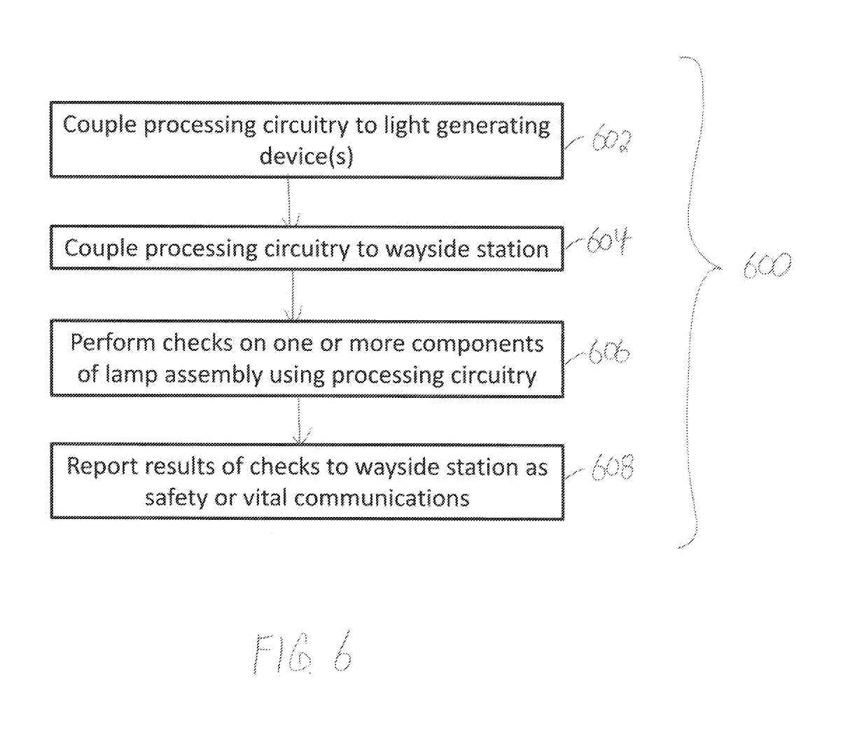

FIG. 6 illustrates a flowchart of one embodiment of a method 600 for providing lamp assemblies in a signaling system. The method 600 may be used to establish and/or operate one or more embodiments of the signaling systems described herein. At 602, processing circuitry of one or more lamp assemblies is communicatively coupled with light generating devices of the lamp assemblies. For example, the processing circuitry may be connected with the light generating devices so that the processing circuitry can monitor operation of the light generating devices, control operation of the light generating devices, or the like.

At 604, the processing circuitry is communicatively coupled with a wayside station. In one embodiment, the processing circuitry of each lamp assembly may be connected with the wayside station by a single conductive pathway such that the wayside station supplies current to power the lamp assembly and receives vital or safety communications from the lamp assembly via the same single conductive pathway. Optionally, the light generating devices and/or processing circuitry of one or more slave lamp assemblies can be communicatively coupled with the processing circuitry of a master lamp assembly, and the processing circuitry of the master lamp assembly can be communicatively coupled with the wayside station. In one embodiment, the communicative coupling between the lamp assemblies and/or between the lamp assemblies and the wayside station can be wired and/or wireless connections.

At 606, checks or tests on one or more components of the lamp assemblies are performed using the processing circuitry in the lamp assemblies. For example, the lamp assemblies may check on operation of the light generating devices using the processing circuitry in the lamp assemblies, and not using circuitry or electronic logic in the wayside station. At 608, the results of these checks or tests can be communicated from the lamp assemblies to the wayside station (e.g., via the single conductive pathway between the lamp assembly and the wayside station or via the wireless connection between the lamp assembly and the wayside station), instead of the wayside station remotely performing these checks or tests via additional wires or cables between the wayside station and the lamp assemblies. The communication of the results of the checks or tests can be referred to as safety or vital communications.

In an embodiment, a system (e.g., a signaling system) includes a first lamp assembly including one or more light generating devices configured to activate to inform an operator of a vehicle system of information related to movement of the vehicle system. The first lamp assembly includes processing circuitry configured to control and monitor operation of the one or more light generating devices. The system also includes a wayside station configured to be communicatively coupled with the first lamp assembly by a single conductive communication pathway. The wayside station is configured to conduct electric current to power the first lamp assembly and to communicate with the processing circuitry of the first lamp assembly via the single conductive communication pathway.

In one aspect, the first lamp assembly includes a signal housing that holds the one or more light generating devices and a signal head. The processing circuitry can be disposed within the signal head.

In one aspect, the first lamp assembly includes a signal housing that holds the one or more light generating devices and a signal head. The processing circuitry can be disposed within the signal housing.

In one aspect, the single conductive communication pathway is a single wire.

In one aspect, the processing circuitry is configured to communicate information about the operation of the one or more light generating devices to the wayside station via the single conductive communication pathway.

In one aspect, the system also includes one or more second lamp assemblies configured to be communicatively coupled with the processing circuitry of the first lamp assembly. The processing circuitry of the first lamp assembly is configured to remotely control and monitor operation of one or more light generating devices in the one or more second lamp assemblies.

In one aspect, the processing circuitry is configured to communicate information about the operation of the one or more light generating devices of the one or more second lamp assemblies to the wayside station via the single conductive communication pathway.

In an embodiment, another system (e.g., another signaling system) includes a first lamp assembly including one or more light generating devices configured to activate to inform an operator of a vehicle system of information related to movement of the vehicle system. The first lamp assembly includes processing circuitry configured to control and monitor operation of the one or more light generating devices. The system also includes a wayside station configured to be communicatively coupled with the first lamp assembly by a wireless communication pathway, wherein the first lamp assembly is configured to communicate with the processing circuitry of the first lamp assembly via the wireless communication pathway.

In one aspect, the first lamp assembly includes a signal housing that holds the one or more light generating devices and a signal head, wherein the processing circuitry is disposed within the signal head.

In one aspect, the first lamp assembly includes a signal housing that holds the one or more light generating devices and a signal head. The processing circuitry can be disposed within the signal housing.

In one aspect, the system also includes one or more second lamp assemblies configured to be communicatively coupled with the processing circuitry of the first lamp assembly. The processing circuitry of the first lamp assembly can be configured to remotely control and monitor operation of one or more light generating devices in the one or more second lamp assemblies.

In one aspect, the processing circuitry is configured to communicate information about the operation of the one or more light generating devices of the one or more second lamp assemblies to the wayside station via the wireless communication pathway.

In one aspect, the system also includes a power source configured to be conductively coupled with the processing circuitry to power the first lamp assembly. The power source can be separate and external from the wayside station.

In an embodiment, another system (e.g., a signaling system) includes a first lamp assembly including one or more light generating devices configured to activate to inform an operator of a vehicle system of information related to movement of the vehicle system. The first lamp assembly includes processing circuitry configured to control and monitor operation of the one or more light generating devices. The first lamp assembly is configured to be communicatively coupled with the wayside station by a single conductive communication pathway. The first lamp assembly is configured to receive electric current to power the first lamp assembly from the wayside station and to communicate with the wayside station via the single conductive communication pathway.

In one aspect, the first lamp assembly includes a signal housing that holds the one or more light generating devices and a signal head. The processing circuitry can be disposed within the signal head.

In one aspect, the first lamp assembly includes a signal housing that holds the one or more light generating devices and a signal head. The processing circuitry can be disposed within the signal housing.

In one aspect, the single conductive communication pathway is a single wire.

In one aspect, the processing circuitry is configured to communicate information about the operation of the one or more light generating devices to the wayside station via the single conductive communication pathway.

In one aspect, the system also can include one or more second lamp assemblies configured to be communicatively coupled with the processing circuitry of the first lamp assembly. The processing circuitry of the first lamp assembly can be configured to remotely control and monitor operation of one or more light generating devices in the one or more second lamp assemblies.

In one aspect, the processing circuitry is configured to communicate information about the operation of the one or more light generating devices of the one or more second lamp assemblies to the wayside station via the single conductive communication pathway.

In an embodiment, a system (e.g., a signaling system) includes a first lamp assembly including one or more light generating devices configured to activate to inform an operator of a vehicle system of information related to movement of the vehicle system. The first lamp assembly includes processing circuitry configured to control and monitor operation of the one or more light generating devices. The first lamp assembly can be configured to be communicatively coupled with the wayside station by a wireless communication pathway, where the first lamp assembly is configured to communicate with the processing circuitry of the first lamp assembly via the wireless communication pathway.

In one aspect, the first lamp assembly includes a signal housing that holds the one or more light generating devices and a signal head. The processing circuitry can be disposed within the signal head.

In one aspect, the first lamp assembly includes a signal housing that holds the one or more light generating devices and a signal head. The processing circuitry can be disposed within the signal housing.

In one aspect, the system also can include one or more second lamp assemblies configured to be communicatively coupled with the processing circuitry of the first lamp assembly. The processing circuitry of the first lamp assembly can be configured to remotely control and monitor operation of one or more light generating devices in the one or more second lamp assemblies.

In one aspect, the processing circuitry is configured to communicate information about the operation of the one or more light generating devices of the one or more second lamp assemblies to the wayside station via the wireless communication pathway.

In one aspect, the system also includes a power source configured to be conductively coupled with the processing circuitry to power the first lamp assembly. The power source can be separate and external from the wayside station.

In an embodiment, a method includes coupling processing circuitry with one or more light generating devices of a first lamp assembly. The one or more light generating devices are configured to activate to inform an operator of a vehicle system of information related to movement of the vehicle system. The method also includes coupling the processing circuitry with a wayside station, monitoring operation of the one or more light generating devices using the processing circuitry of the first lamp assembly, and communicating information about the operation of the one or more light generating devices to the wayside station from the processing circuitry.

In one aspect, coupling the processing circuitry with the wayside station includes connecting the processing circuitry with the wayside station with a single conductive pathway.

In one aspect, the method also includes conducting current to the processing circuitry and the one or more light generating devices via the single conductive pathway. The information about the operation of the one or more light generating devices is communicated via the single conductive pathway.

In one aspect, the method includes remotely controlling and monitoring operation of one or more light generating devices in one or more second lamp assemblies using the processing circuitry in the first lamp assembly.

In one aspect, coupling the processing circuitry with the wayside station includes communicatively coupling the processing circuitry with the wayside station via a wireless communication pathway.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended clauses, along with the full scope of equivalents to which such clauses are entitled. In the appended clauses, the terms “including” and “in which” are used as the plain-English equivalents of the respective terms “comprising” and “wherein.” Moreover, in the following clauses, the terms “first,” “second,” and “third,” etc. are used merely as labels, and are not intended to impose numerical requirements on their objects. Further, the limitations of the following clauses are not written in means-plus-function format and are not intended to be interpreted based on 35 U.S.C. §112, sixth paragraph, unless and until such clause limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter may include other examples that occur to those of ordinary skill in the art. Such other examples are intended to be within the scope of the clauses if they have structural elements that do not differ from the literal language of the clauses, or if they include equivalent structural elements with insubstantial differences from the literal languages of the clauses.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “an embodiment” or “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

1. A system comprising:
a first lamp assembly including one or more light generating devices configured to activate to inform an operator of a vehicle system of information related to movement of the vehicle system, the first lamp assembly including processing circuitry configured to control and monitor operation of the one or more light generating devices; and
a wayside station configured to be communicatively coupled with the first lamp assembly by a single conductive communication pathway, wherein the wayside station is configured to conduct electric current to power the first lamp assembly and to communicate with the processing circuitry of the first lamp assembly via the single conductive communication pathway.

2. The system of claim 1, wherein the first lamp assembly includes a signal housing that holds the one or more light generating devices and a signal head, wherein the processing circuitry is disposed within the signal head.

3. The system of claim 1, wherein the first lamp assembly includes a signal housing that holds the one or more light generating devices and a signal head, wherein the processing circuitry is disposed within the signal housing.

4. The system of claim 1, wherein the single conductive communication pathway is a single wire.

5. The system of claim 1, wherein the processing circuitry is configured to communicate information about the operation of the one or more light generating devices to the wayside station via the single conductive communication pathway.

6. The system of claim 1, further comprising one or more second lamp assemblies configured to be communicatively coupled with the processing circuitry of the first lamp assembly, wherein the processing circuitry of the first lamp assembly is configured to remotely control and monitor operation of one or more light generating devices in the one or more second lamp assemblies.

7. The system of claim 6, wherein the processing circuitry is configured to communicate information about the operation of the one or more light generating devices of the one or more second lamp assemblies to the wayside station via the single conductive communication pathway.

8. A system comprising:
a first lamp assembly including one or more light generating devices configured to activate to inform an operator of a vehicle system of information related to movement of the vehicle system, the first lamp assembly including processing circuitry configured to control and monitor operation of the one or more light generating devices; and
a wayside station configured to be communicatively coupled with the first lamp assembly by a wireless communication pathway, wherein the wayside station is configured to communicate with the processing circuitry of the first lamp assembly via the wireless communication pathway.

9. The system of claim 8, wherein the first lamp assembly includes a signal housing that holds the one or more light generating devices and a signal head, wherein the processing circuitry is disposed within the signal head.

10. The system of claim 8, wherein the first lamp assembly includes a signal housing that holds the one or more light generating devices and a signal head, wherein the processing circuitry is disposed within the signal housing.

11. The system of claim 8, further comprising one or more second lamp assemblies configured to be communicatively coupled with the processing circuitry of the first lamp assembly, wherein the processing circuitry of the first lamp assembly is configured to remotely control and monitor operation of one or more light generating devices in the one or more second lamp assemblies.

12. The system of claim 11, wherein the processing circuitry is configured to communicate information about the operation of the one or more light generating devices of the one or more second lamp assemblies to the wayside station via the wireless communication pathway.

13. The system of claim 8, further comprising a power source configured to be conductively coupled with the processing circuitry to power the first lamp assembly, wherein the power source is separate and external from the wayside station.

14. A method comprising:
coupling processing circuitry with one or more light generating devices of a first lamp assembly, the one or more light generating devices configured to activate to inform an operator of a vehicle system of information related to movement of the vehicle system;
coupling the processing circuitry with a wayside station;
monitoring operation of the one or more light generating devices using the processing circuitry of the first lamp assembly; and
communicating information about the operation of the one or more light generating devices to the wayside station from the processing circuitry.

15. The method of claim 14, wherein coupling the processing circuitry with the wayside station includes connecting the processing circuitry with the wayside station with a single conductive pathway.

16. The method of claim 15, further comprising conducting current to the processing circuitry and the one or more light generating devices via the single conductive pathway, and wherein the information about the operation of the one or more light generating devices is communicated via the single conductive pathway.

17. The method of claim 14, further comprising remotely controlling and monitoring operation of one or more light generating devices in one or more second lamp assemblies using the processing circuitry in the first lamp assembly.

18. The method of claim 14, wherein coupling the processing circuitry with the wayside station includes communicatively coupling the processing circuitry with the wayside station via a wireless communication pathway.
